(19) United States
(12) Patent Application Publication
(10) Pub. No.: US 2020/0337111 A1
(43) Pub. Date: Oct. 22, 2020

(54) Network Node, Radio Network Node and Methods Performed Therein for Handling One or More Protocol Data Unit (PDU) Sessions

(71) Applicant: Telefonaktiebolaget LM Ericsson (publ), Stockholm (SE)

(72) Inventors: Nianshan SHI, Järfälla (SE); Matteo FIORANI, Solna (SE)

(21) Appl. No.: 16/764,017

(22) PCT Filed: Nov. 13, 2018
(86) PCT No.: PCT/SE2018/051158

§ 371 Date: May 14, 2020

Related U.S. Application Data
(60) Provisional application No. 62/587,569, filed on Nov. 17, 2017.

(51) Int. Cl. H04W 76/34; H04L 12/911; H04W 28/02; H04L 12/927; H04L 29/08; H04W 80/10

(52) U.S. Cl. CPC H04W 76/34; H04L 47/748; H04L 47/746; H04W 80/10; H04L 47/805; H04L 67/143; H04W 28/0236

(57) ABSTRACT

Embodiments herein relate to e.g. a radio network node (12) for handling an update of a protocol data unit, PDU, session, for a wireless device (10) in a wireless communication network (1). The radio network node (12) is configured to transmit to a network node (13), an indication indicating one or more quality of service, QoS, flows or PDU sessions to be released. The radio network node (12) is further configured to receive a confirmation indication from the network node (13), wherein the confirmation indication indicates one or more QoS flows or PDU sessions released and/or not released; and to handle the update of the PDU session based on the received confirmation indication.

### TECHNICAL FIELD

Embodiments herein relate to a network node, a radio network node and methods performed therein regarding wireless communication. In particular, embodiments herein relate to handling communication of a wireless device in a wireless communication network such as handling an update of a protocol data unit (PDU) session, for the wireless device in the wireless communication network.

### BACKGROUND

In a typical wireless communication network, wireless devices, also known as wireless communication devices, mobile stations, stations (STA) and/or user equipment (UE), communicate via a Radio Access Network (RAN) to one or more core networks (CN). The RAN covers a geographical area which is divided into service areas or cells, with each service area or cell area being served by a radio network node e.g., a Wi-Fi access point or a radio base station (RBS), which in some networks may also be called, for example, a “NodeB”, “eNodeB” or “gNodeB”. The service area or cell is a geographical area where radio coverage is provided by the radio network node. The radio network node operates on radio frequencies to communicate over an air interface with the wireless devices within range of the radio network node. The radio network node communicates over a downlink (DL) to the wireless device and the wireless device communicates over an uplink (UL) to the radio network node.

A Fifth Generation (5G) system comprises a 5G Core (5GC) and a Next Generation (NG)-RAN node. The 5G system defines the association between a wireless device and a Data Network that provides a protocol data unit (PDU) connectivity service as a PDU session. A 5G Quality of Service (QoS) model is based on QoS Flows. The PDU sessions comprise one or more QoS flows. FIG. 1 shows a PDU session architecture showing QoS flows of a PDU session over radio bearers and a NG-user data (U) tunnel from a UE, i.e. a wireless device, to a user plane function (UPF). After the PDU session and the related QoS flows are established, it is possible to modify the QoS flows or the whole PDU session, e.g. to modify the transport layer information. It is also possible for 5GC to add or release QoS flows to the already established PDU session.

There is a present procedure related to NG-RAN Node initiated QoS flow or PDU session release which is shown in FIG. 2, wherein the NG-RAN node transmits a message, i.e. a PDU session resource notify message, to an Access and Mobility Management Function (AMF) node. In this procedure, a list of QoS flows which are released by the NG-RAN node is included in the message. Furthermore, a session management function (SMF) node normally initiate an appropriate release procedure, in order to release those QoS flows. FIG. 3 shows that 5GC initiates the release procedure upon following the procedure in FIG. 2. The AMF node is a core network node providing an Access and Mobility Management Function. Thus, there are two procedures with three next generation application protocol (NGAP) messages that are needed if “PDU Session Resource Notify” is used to release the QoS flows or PDUs, i.e. a PDU session resource modify message and a PDU session resource modify acknowledgement (Ack) message. It is totally up to a SMF node in the 5GC to initiate a release procedure or not, after the NG-RAN node has sent the PDU Session Resource Notify indicating that the QoS flows are released.

But what would happen if for some reason that SMF node does not initiate the release procedure, or if the SMF node at the same time initiate a modification procedure to modify the involved QoS flows?

For sure when the NG-RAN node wishes to release a certain QoS flow, the NG-RAN node means that the RAN cannot keep the QoS flows any more. To break this release into two procedures would imply that RAN needs to handle the above problematic cases and it may cause ambiguity and inconsistence between 5GC and NG-RAN, and there is no robustness. It also increases NGAP signalling, that is the signalling over NG interfaces. There is a PDU Session Resource Modify Indication procedure in the specification but this procedure is only used to modify the Down Link Transport layer address, which is Downlink Transport network Layer (DL TNL) Information. Thus, the above mentioned ambiguity and increased NGAP signalling may result in a limited performance of the wireless communication network.

### SUMMARY

An object herein is to provide a mechanism to overcome the ambiguity in a resource efficient manner, i.e. handle PDU sessions and modification of PDU sessions in an efficient manner.

According to an aspect the object is achieved, according to embodiments herein, by providing a method performed by a radio network node for handling one or more protocol data unit sessions of a wireless device in a wireless communication network. The radio network node transmits an indication, to a network node e.g. an AMF node, which indication indicates one or more QoS flows or PDU sessions to be released. The radio network node further receives a confirmation indication from the network node. The confirmation indication indicates one or more QoS flow or PDU sessions released and/or not released. The radio network node further handles an update of the PDU session based on the received confirmation indication e.g. ensures that one or more QoS flow or PDU session at non access stratum (NAS) level.

According to another aspect the object is achieved, according to embodiments herein, by providing a method performed by a network node, such as an AMF node or an SMF node, for handling one or more protocol data unit sessions of a wireless device in a wireless communication network. The network node receives an indication from a radio network node. The indication indicates one or more QoS flows or PDU sessions, of the wireless device, to be released. The network node then transmits a confirmation indication to the radio network node, which confirmation indication indicates one or more QoS flows or PDU sessions released or not released e.g. successfully released and failed released.

It is furthermore provided herein a computer program product comprising instructions, which, when executed on at least one processor, cause the at least one processor to carry out any of the methods above, as performed by the radio network node or the network node. It is additionally provided herein a computer-readable storage medium, having stored thereon a computer program product comprising instructions which, when executed on at least one processor, cause the at least one processor to carry out the method according to any of the methods above, as performed by the radio network node or the network node.

According to embodiments herein a radio network node is provided for handling an update of a PDU session, for a wireless device in a wireless communication network. The radio network node is configured to transmit to a network node, an indication indicating one or more QoS flows or PDU sessions to be released. The radio network node is further configured to receive a confirmation indication from the network node, wherein the confirmation indication indicates one or more QoS flows or PDU sessions released and/or not released; and to handle the update of the PDU session based on the received confirmation indication.

According to embodiments herein a network node is provided for handling an update of a PDU session for a wireless device in a wireless communication network. The network node is configured to receive an indication from a radio network node, wherein the indication indicates one or more QoS flows or PDU sessions to be released. The network node is further configured to transmit a confirmation indication to the radio network node, which confirmation indication indicates one or more QoS flows or PDU sessions released or not released.

Embodiments herein provide a quick and robust procedure for release of a QoS flow (of a PDU session) and/or a PDU session initiated by the radio network node. The inconsistence and ambiguity that may be caused by the existing procedure is resolved. Embodiments further enable or offer a reliable solution for the end-to-end removal of e.g. network slices in a wireless device, an NG-RAN node and the 5GC.

### BRIEF DESCRIPTION OF THE DRAWINGS

Embodiments will now be described in more detail in relation to the enclosed drawings, in which:

FIG. 1 is a block diagram depicting a PDU session;

FIG. 2 is a signalling scheme depicting a PDU session resource notify procedure;

FIG. 3 is a signalling scheme depicting the PDU session resource notify message that is followed by a 5GC initiated modification procedure;

FIG. 4 is a schematic overview depicting a wireless communication network according to embodiments herein;

FIG. 5 shows a combined flowchart and signalling scheme according to embodiments herein;

FIG. 6 shows a schematic flowchart depicting a method performed by a radio network node according to embodiments herein;

FIG. 7 shows a schematic flowchart depicting a method performed by a network node according to embodiments herein;

FIG. 8 is a block diagram depicting a radio network node according to embodiments herein;

FIG. 9 is a block diagram depicting a network node according to embodiments herein;

FIG. 10 shows a telecommunication network connected via an intermediate network to a host computer in accordance with some embodiments;

FIG. 11 shows a host computer communicating via a base station with a user equipment over a partially wireless connection in accordance with some embodiments;

FIG. 12 shows methods implemented in a communication system including a host computer, a base station and a user equipment in accordance with some embodiments;

FIG. 13 shows methods implemented in a communication system including a host computer, a base station and a user equipment in accordance with some embodiments;

FIG. 14 shows methods implemented in a communication system including a host computer, a base station and a user equipment in accordance with some embodiments; and

FIG. 15 shows methods implemented in a communication system including a host computer, a base station and a user equipment in accordance with some embodiments; and

FIG. 16 is a signalling scheme depicting the PDU session resource modify indication that is followed by a PDU session resource modify confirmation.

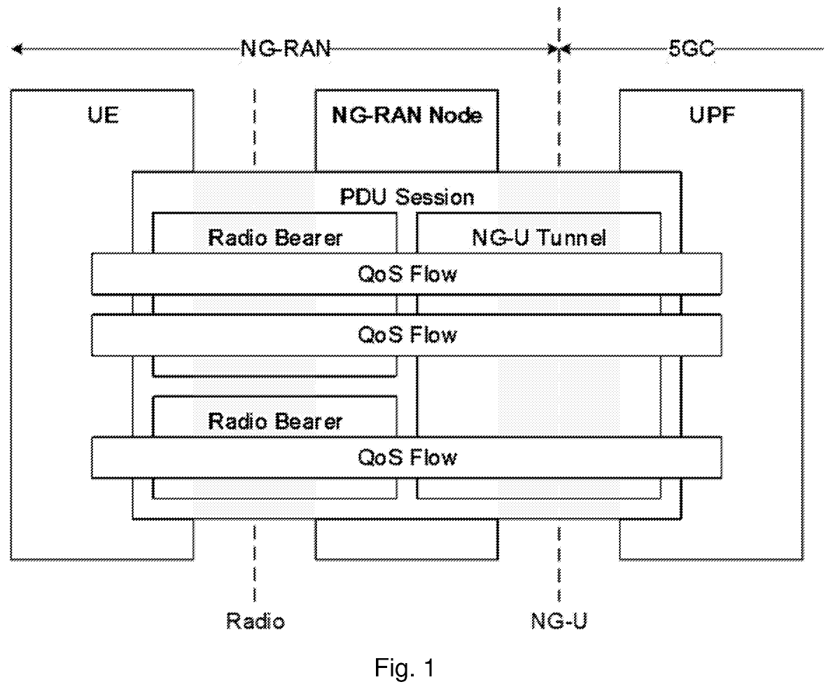

### DETAILED DESCRIPTION

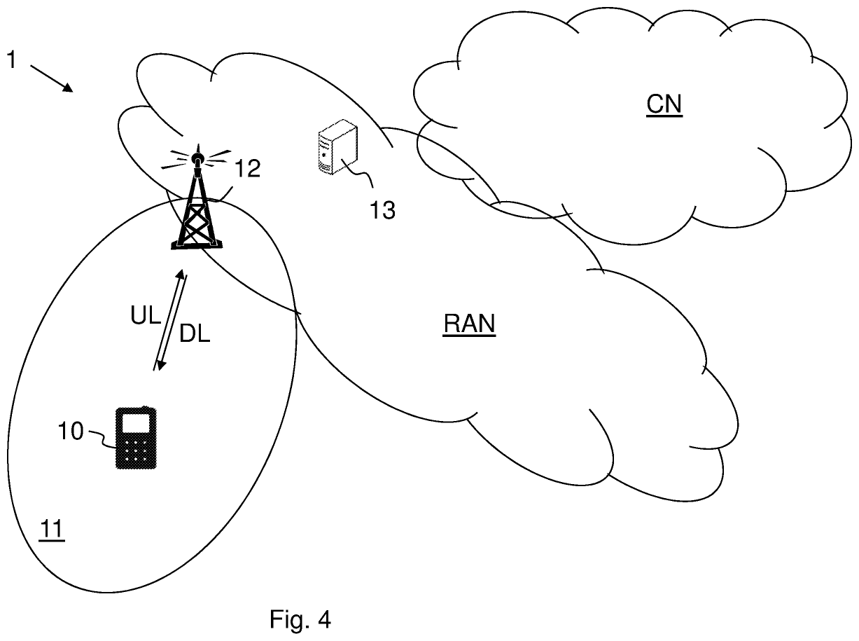

Additional information may also be found in the document(s) provided in the Appendix A. Embodiments herein relate to wireless communication networks in general. FIG. 4 is a schematic overview depicting a wireless communication network 1. The wireless communication network 1 comprises one or more RANs and one or more CNs. The wireless communication network 1 may use one or a number of different technologies. Embodiments herein relate to recent technology trends that are of particular interest in a 5G context, however, embodiments are also applicable in further development of existing wireless communication systems such as e.g. LTE and Wideband Code Division Multiple Access (WCDMA).

In the wireless communication network 1, wireless devices e.g. a wireless device 10 such as a mobile station, a non-access point (non-AP) STA, a STA, a user equipment and/or a wireless terminal, communicate via one or more Access Networks (AN), e.g. RAN, to one or more core networks (CN). It should be understood by the skilled in the art that “wireless device” is a non-limiting term which means any terminal, wireless communication terminal, user equipment, Narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communication network 1 comprises a radio network node 12 providing radio coverage over a geographical area, a service area 11 or a cell, of a first radio access technology (RAT), such as NR or similar. The radio network node 12 may be a transmission and reception point such as an access node, an access controller, a base station, e.g. a radio base station such as a gNodeB (gNB), an evolved Node B (eNB, eNode B), a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node 12 depending e.g. on the first radio access technology and terminology used. The radio network node 12 may be referred to as a serving radio network node wherein the service area may be referred to as a serving cell, and the serving network node communicates with the wireless device 10 in form of DL transmissions to the wireless device 10 and UL transmissions from the wireless device 10. It should be noted that a service area may be denoted as cell, beam, beam group or similar to define an area of radio coverage.

The wireless communication network 1 may further comprises a network node 13 e.g. a core network node such as a AMF node or an SMF node for handling mobility and similar matters.

It is herein suggested possible solutions for a QoS flow or PDU session release initiated by the radio network node 12. The radio network node 12 is herein exemplified as a NG-RAN node also known as gNodeB (gNB) and the network node 13 is exemplified as an AMF node.

A class 1 procedure may be used for the radio network node 12 to initiate the QoS flow or PDU session release. A class 1 procedure is an elementary procedure with a response, which response indicates success and/or failure. Upon the reception of a release request message from the radio network node 12, the network node 13 understands that the radio network node 12 will release the given QoS flow and/or PDU sessions and related resources, e.g. time and frequency resources. The network node 13 confirms the release e.g. may confirm that the release is successful or fails. The network node 13 confirms that the QoS flows or PDU sessions has been successfully released. The network node 13 may further send a related Non Access Stratum (NAS)-PDU to the radio network node 12, and upon the reception of the confirmation from network node 13, the radio network node 12 may pass the NAS-PDU received for the PDU session to the wireless device 10 and de-associate i.e. release the corresponding resources. The wireless device 10 is thus informed that the QoS flows (or PDU session) can be released at NAS level and can free the corresponding resources.

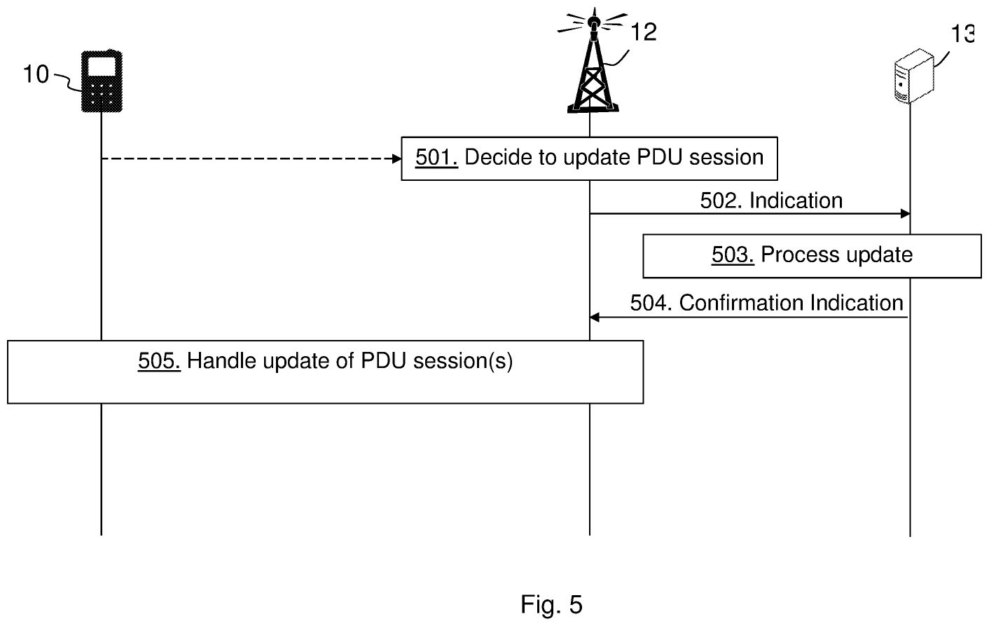

FIG. 5 is a combined flowchart and signaling scheme according to embodiments herein. As there is an existing “PDU Session Resource Modify Indication” procedure, this procedure may be used as the baseline. It is also possible to define a new procedure.

Action 501. When a condition changes e.g. a change in load and/or throughput, and/or a lack of resources occurs, and/or an inactivity is detected e.g. no actual data transmitted for a given time, and/or poor radio conditions e.g. signal strength or quality is below a threshold value, the radio network node 12 decides to update a PDU session e.g. decides to release already established one or more QoS flows of a PDU session or one or more PDU sessions.

Action 502. The radio network node 12 initiates a release procedure, transmitting an indication indicating one or more quality of service, QoS, flows or PDU sessions to be released, e.g. transmit a message with one or more indications indicating one or more QoS flows or PDU sessions to be released. If all the QoS flows in a PDU session are to be released, the radio network node 12 may indicate that the PDU session is released. A cause value may be provided to network node 13 to indicate the reason for release, e.g. increased load, changed radio conditions, the data bearer has been inactive or similar. The indication may be comprised in a release request message that is sent to e.g. 5GC such as the AMF node, the network node 13 may then invoke the appropriate procedure in the SMF node in 5GC. The indication may be a PDU Session Resource Modify Indication. The cause value may thus e.g. indicate lack of resources, inactivity (no actual data transmitted for a given time), or poor radio conditions. The network node may be a Distributed Node (DN) and functionality, e.g. comprised in a cloud that may be used for performing or partly performing the methods. The AMF node may be collocated with the SMF node and/or the AMF node may be a server, a stand-alone node, or a logical node.

Action 503. The network node 13 may process the release request from radio network node 12. E.g. the network node 13 being e.g. an AMF node may contact a User plane function (UPF) node to perform the release of the resources, e.g., release transport addresses as well as hardware/software resources. This also informs the UPF node that no more traffic should be sent for this QoS flow and/or PDU session. The AMF node and the UPF node may be collocated or stand alone nodes.

Action 504. The network node 13 then transmits a confirmation indication back to the radio network node 12 when at least one QoS flow or PDU session is released successfully. The confirmation includes one or more QoS flows or PDU sessions being successfully released and/or one or more QoS flows or PDU sessions failed to be released. For each PDU session or the PDU sessions where some QoS Flows are released successfully, the NAS-PDU of the respective QoS flow may be included. The network node 13 may also include the one or more QoS flows or PDU sessions failed to be released and a failure cause. For the QoS flow or PDU sessions failed to be released, a special cause value may be introduced to indicate to radio network node 12 that it shall not release the QoS flow or PDU session at any cost. For the other causes values, it is then up to radio network node implementation to either release or to resent the release request again. The confirmation indication may be a PDU Session Resource Modify Confirm.

Action 505. Upon the reception of the confirmation indication from the network node 13, the radio network node 12 handles the update of the PDU session(s). E.g. the radio network node 12 may pass the NAS-PDU received for the PDU session to the wireless device 10. This is to ensure that wireless device 10 removes one or more QoS flow or PDU session at NAS level. Radio network node 12 may initiate a reconfiguration towards the wireless device 10. The radio network node 12 may de-associate a corresponding Data Radio Bearer for the released one or more QoS flows or PDU sessions. Thus, the network node 13, e.g. AMF node, may send a NAS message to the wireless device 10 to inform that the QoS flow and/or PDU session is removed. The wireless device 10 may then remove all the information associated to the QoS flow and/or PDU session and release corresponding resources.

It should also be noted that a PDU session may be mapped to a network slice. A network slice may be associated to a specific service and may belong to a given vertical, e.g., police slice, automotive slice. Therefore, the proposed mechanism offers a reliable solution for the end-to-end removal of network slices in the wireless device 10, radio network node 12 and the 5GC. Embodiments herein may be implemented for slices providing critical services in order to avoid misconfigurations that can have serious consequences. Thus, this results in an efficient procedure of handling sessions leading to an improved performance of the wireless communication network.

Thus, a network slice may be associated to a specific service and may belong to a given vertical, e.g., police slice, automotive slice. Embodiments herein may offer a reliable solution for an end-to-end removal of a network slice in the wireless device 10, the radio network node 12 and the network node 13. Embodiments herein may be implemented for network slices providing critical services in order to avoid misconfigurations that can have serious consequences. The radio network node 12 may thus determine that the PDU session or QoS flows of a network slice is to be released and inform the network node 13 as shown in FIG. 5.

Tables 1-3 below show an example of embodiments herein implemented in TS 38.413 v0.4.0. Other message or Information elements, new Information elements may be used instead.

In Table 1, the information is sent in the message from the radio network node 12 to the network node 13. New structure may be introduced to convey the QoS flows or PDU sessions to be released.

In Table 2 the NAS-PDU is included per PDU session (involved in the release) and is sent from the network node 13 to the radio network node 12. The radio network node 12 may then pass the NAS-PDUs to the wireless device 10.

In Table 3, the QoS flows and PDU sessions released successfully and failed are introduced in an information element (IE), it is sent in the confirmation from the network node 13 to the radio network node 12. A Special cause value to not allow the radio network node 12 to release may be introduced.

TABLE 1
The new structure introducing a choice and including the
QoS flows Released and PDU sessions Released in “9.3.1.19
PDU Session Resource Modify Indication Transfer”

| | | | | |
|---|---|---|---|---|
| | | | IE type and | Semantics |
| IE/Group Name | Presence | Range | reference | description |

| | | | |
|---|---|---|---|
| CHOICE PDU Session | | | |
| Resource Modify | | | |
| Indication Transfer | M | | |
| >PDU Session Modify | | | |
| >>DL TNL | M | TNL | One or |
| Information | | Information | multiple |
| | | 9.3.2.1 | RAN |
| | | | Transport |
| | | | Layer |
| | | | Information |
| >QoS Flows | | | |
| Released | | | |
| >>QoS Flows | M | QoS Flow | |
| Release List | | List | |
| | | <ref> | |
| >>Cause | O | ref | Indicate |
| | | | the release |
| | | | reasons |
| >PDU Session | | | |
| Released | | | |
| >>Cause | O | ref | Indicate |
| | | | the release |
| | | | reasons |

TABLE 2
Add a new IE “NAS-PDU” under each PDU session in 9.2.1.9
“PDU SESSION RESOURCE MODIFY CONFIRM”

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | 9.3.1.1 | YES | reject |
| AMF UE NGAP ID | M | | 9.3.3.1 | YES | reject |
| RAN UE NGAP ID | M | | 9.3.3.2 | YES | reject |
| PDU Session | | 0 . . . 1 | | YES | reject |
| Resource Modify | | | | | |
| Confirm List | | | | | |
| >PDU Session | | 1 . . . | | EACH | reject |
| Resource Modify | | <maxnoofPDUSessions> | | | |
| Confirm Item IEs | | | | | |
| >>PDU Session ID | M | | <ref> | — | |
| >>PDU Session | M | | 9.3.1.20 | — | |
| Resource Modify | | | | | |
| Confirm Transfer | | | | | |
| >>NAS-PDU | O | | 9.3.3.4 | | |
| >>S-NSSAI [FFS] | O | | <ref> | — | |
| Criticality Diagnostics | O | | 9.3.1.3 | YES | ignore |

TABLE 3
Add new IEs for PDU session resource released successfully and failed
in “9.3.1.20 PDU Session Resource Modify Confirm Transfer”

| | | | IE type and | Semantics | | Assigned |
|---|---|---|---|---|---|---|
| IE/Group Name | Presence | Range | reference | description | Criticality | Criticality |
| CHOICE PDU Session | M | | | | YES | reject |
| Resource Modify | | | | | | |
| Confirm Transfer | | | | | | |
| >PDU Session | | | | | — | |
| Resource Modify | | | | | | |
| Success Confirm | | | | | | |
| >>QoS Flows Modify | | 1 | | | — | |
| List | | | | | | |
| >>>QoS Flows | | 1 . . . | | | — | |
| Modify Item IEs | | <maxnoofQoSFlows> | | | | |
| >>>>QoS Flow | M | | <ref> | | EACH | reject |
| Indicator | | | | | | |
| >>QoS Flows Failed | O | | QoS Flow List | | YES | ignore |
| To Modify List | | | <ref> | | | |
| >PDU Session | | | | | — | |
| Resource Modify | | | | | | |
| Failure Confirm [FFS] | | | | | | |
| >>Cause [FFS] | M | | 9.3.1.2 | | — | |
| >PDU Session | | | | | — | |
| Resource Released | | | | | | |
| Success Confirm | | | | | | |
| >>QoS Flows | O | | QoS Flow List | | YES | reject |
| Release List | | | <ref> | | | |
| >>QoS Flows Failed | O | | QoS Flow List | | YES | ignore |
| To Release List | | | <ref> | | | |
| >>Cause | M | | ref | Indicate the failure | — | |
| | | | | cause | | |
| >PDU Session | | | | | — | |
| Resource Release | | | | | | |
| Failure Confirm | | | | | | |
| >>Cause | M | | ref | Indicate the failure | — | |
| | | | | cause | | |

Embodiments herein allow a quick and robust procedure for the radio network node 12, such as NG-RAN node, (access stratum) initiated QoS flow and PDU session release. It solves the inconsistence and ambiguity that may be caused by the existing procedure and saves NGAP signaling.

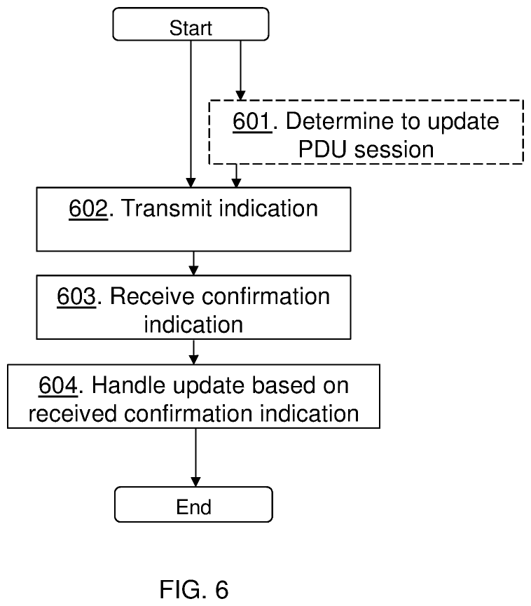

The method actions performed by the radio network node 12 for handling update of a PDU session, e.g. handling release of one or more QoS flows of a PDU session, for the wireless device 10, in the wireless communication network 1 according to embodiments will now be described with reference to a flowchart depicted in FIG. 6. The actions do not have to be taken in the order stated below, but may be taken in any suitable order. Actions performed in some embodiments are marked with dashed boxes.

Action 601. The radio network node 12 may determine to update the PDU session of the wireless device, e.g. release one or more QoS of the PDU session or one or more PDU sessions.

Action 602. The radio network node 12 transmits the indication indicating one or more QoS flows or one or more PDU sessions to be released. The radio network node 12 may further transmit cause indication indicating cause of the release.

Action 603. The radio network node 12 receives the confirmation indication from the network node 13. The confirmation indication indicates one or more QoS flow or one or more PDU sessions released and/or not released.

Action 604. The radio network node 12 further handles the update of the PDU session based on the received confirmation indication. E.g. the radio network node 12 may e.g. handle release of the one or more QoS flows of the PDU session, and/or pass the NAS-PDU received for the PDU session to the wireless device 10. Additionally or alternatively, the radio network node 12 may initiate a reconfiguration towards the wireless device 10, and/or the radio network node 12 may de-associate the corresponding Data Radio Bearer for the released one or more QoS flows or PDU sessions.

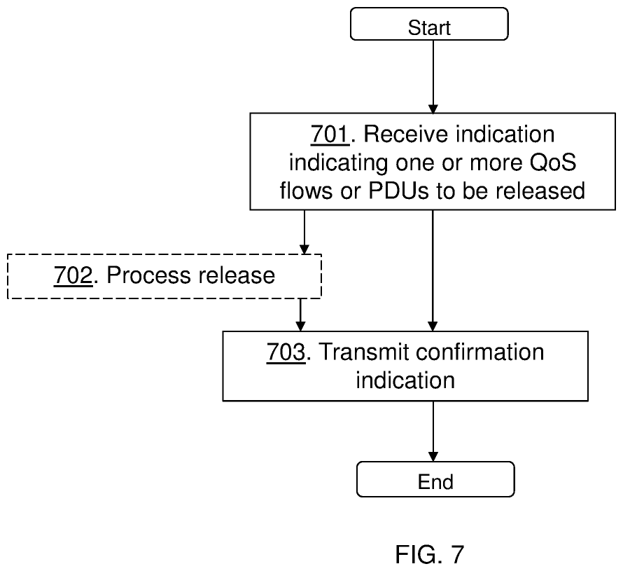

The method actions performed by the network node 13 for handling for handling update of a PDU session, e.g. handling release of one or more QoS flows of the PDU session, for the wireless device 10, in the wireless communication network 1 according to embodiments will now be described with reference to a flowchart depicted in FIG. 7. The actions do not have to be taken in the order stated below, but may be taken in any suitable order. Actions performed in some embodiments are marked with dashed boxes.

Action 701. The network node 13 receives the indication from the radio network node 12. The indication indicates one or more QoS flows or one or more PDU sessions to be released. The network node 13 may further receive the cause indication indicating cause of the release.

Action 702. The network node 13 may further process the one or more QoS flows or one or more PDU sessions. E.g. attempt to release resources for the indicated one or more QoS flows or one or more PDU sessions.

Action 703. The network node 13 then transmits the confirmation indication to the radio network node 12, which confirmation indication indicates one or more QoS flows or one or more PDU sessions released or not released i.e. successfully released and failed released.

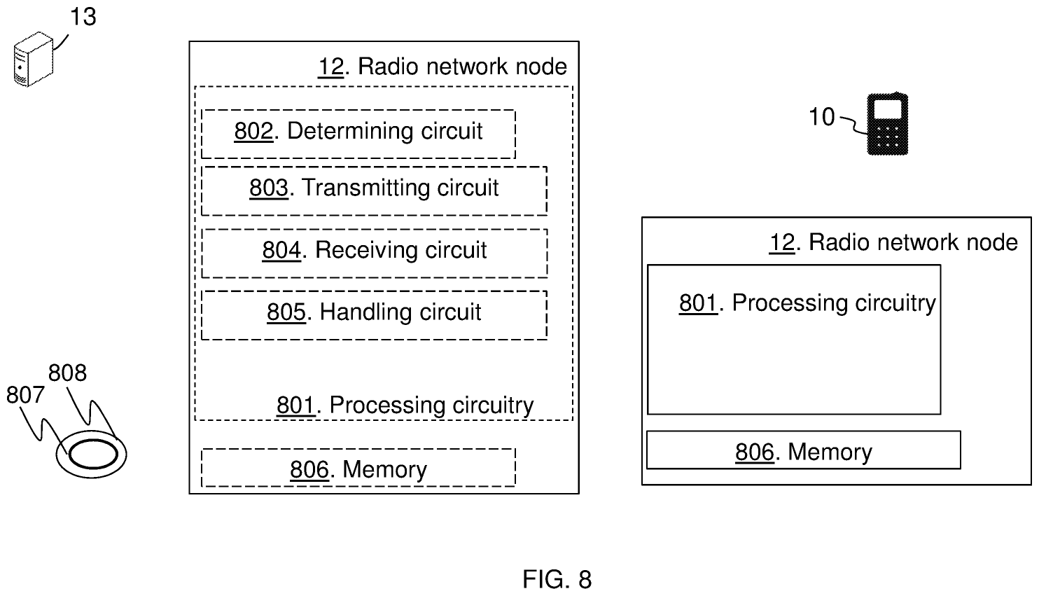

FIG. 8 is a block diagram depicting the radio network node 12 for handling communication according to embodiments herein.

The radio network node 12 may comprise processing circuitry 801, e.g. one or more processors, configured to perform the methods herein.

The radio network node 12 may comprise a determining circuit 802. The radio network node 12, the processing circuitry 801, and/or the determining circuit 802 may be configured to determine to update the PDU session of the wireless device, e.g. release one or more QoS of the PDU session or one or more PDU sessions, or release a network slice.

The radio network node 12 may comprise a transmitting circuit 803, e.g. transmitter or transceiver. The radio network node 12, the processing circuitry 801, and/or the transmitting circuit 803 is configured to transmit the indication indicating one or more QoS flows or PDU sessions to be released.

The radio network node 12 may comprise a receiving circuit 804, e.g. receiver or transceiver. The radio network node 12, the processing circuitry 801, and/or the receiving circuit 804 is configured to receive the confirmation indication from the network node 13. The confirmation indication indicates one or more QoS flow or PDU sessions released and/or not released.

The radio network node 12 may comprise a handling circuit 805. The radio network node 12, the processing circuitry 801, and/or the handling circuit 805 is configured to handle the update of the PDU session based on the confirmation indication.

The radio network node 12 further comprises a memory 806. The memory comprises one or more units to be used to store data on, such as indications, confirmation indications, PDU information, QoS flows information, applications to perform the methods disclosed herein when being executed, and similar. The radio network node 12 may comprise a communication interface comprising e.g. a receiver, a transmitter, a transceiver and/or one or more antennas.

The methods according to the embodiments described herein for the radio network node 12 are respectively implemented by means of e.g. a computer program product 807 or a computer program, comprising instructions, i.e., software code portions, which, when executed on at least one processor, cause the at least one processor to carry out the actions described herein, as performed by the radio network node 12. The computer program product 807 may be stored on a computer-readable storage medium 808, e.g. a disc, a universal serial bus (USB) stick or similar. The computer-readable storage medium 808, having stored thereon the computer program product, may comprise the instructions which, when executed on at least one processor, cause the at least one processor to carry out the actions described herein, as performed by the radio network node 12. In some embodiments, the computer-readable storage medium may be a transitory or a non-transitory computer-readable storage medium.

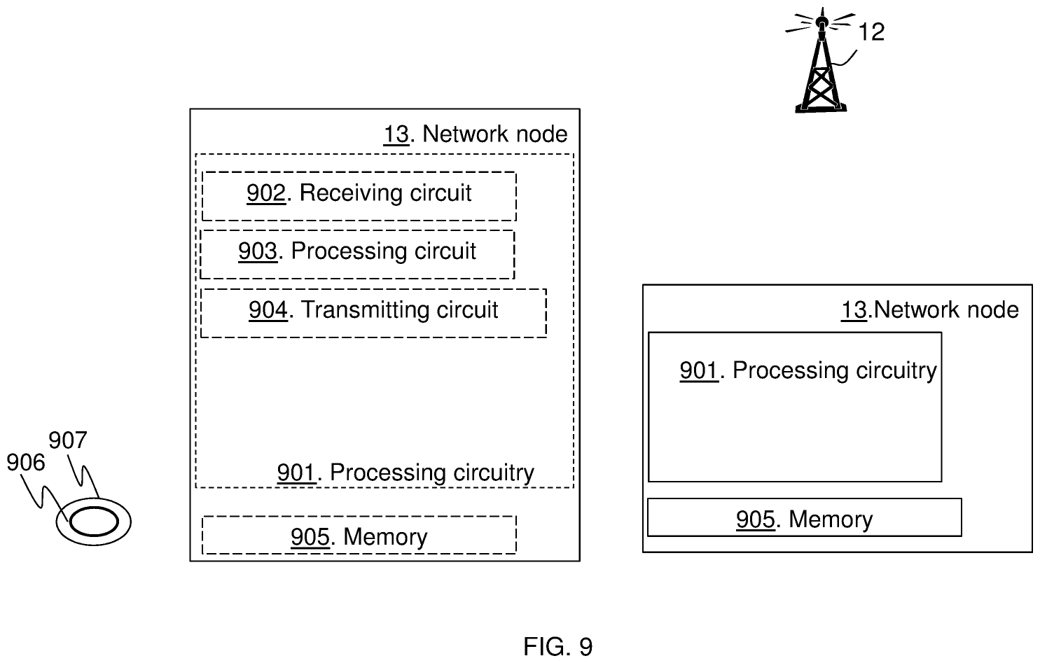

FIG. 9 is a block diagram depicting the network node 13 for handling one or more PDU sessions of the wireless device in a wireless communication network according to embodiments herein.

The network node 13 may comprise processing circuitry 901, such as one or more processors, configured to perform methods herein.

The network node 13 may comprise a receiving circuit 902, e.g. a receiver or transceiver. The wireless device 10, the processing circuitry 901, and/or the receiving circuit 902 is configured to receive the indication from the radio network node 12. The indication indicates one or more QoS flows or PDU sessions to be released.

The network node 13 may comprise a processing circuit 903. The wireless device 10, the processing circuitry 901, and/or the processing circuit 903 may be configured to process the one or more QoS flows or PDU sessions. E.g. attempt to release resources for the indicated one or more QoS flows or PDU sessions. The network node 13 may comprise a transmitting circuit 904, e.g. a transmitter or transceiver. The wireless device 10, the processing circuitry 901, and/or the transmitting circuit 904 is configured to transmit the confirmation indication to the radio network node, which confirmation indication indicated one or more QoS flows or PDU sessions released or not released i.e. successfully released and failed released.

The network node 13 further comprises a memory 905. The memory comprises one or more units to be used to store data on, such as indications, confirmation indications, PDU information, QoS flows information, applications to perform the methods disclosed herein when being executed, and similar. The network node 13 may comprise a communication interface comprising e.g. a receiver, a transmitter, and/or a transceiver.

The methods according to the embodiments described herein for the network node 13 are respectively implemented by means of e.g. a computer program product 906 or a computer program, comprising instructions, i.e., software code portions, which, when executed on at least one processor, cause the at least one processor to carry out the actions described herein, as performed by the network node 13. The computer program product 906 may be stored on a computer-readable storage medium 907, e.g. a disc, a USB stick or similar. The computer-readable storage medium 907, having stored thereon the computer program product, may comprise the instructions which, when executed on at least one processor, cause the at least one processor to carry out the actions described herein, as performed by the network node 13. In some embodiments, the computer-readable storage medium may be a transitory or a non-transitory computer-readable storage medium.

When looking at the wide range of applications and use cases that are addressed with a 5G network, it is quite obvious these cannot effectively be addressed with a traditional approach of having a purpose built network for each application. This will lead to high cost for networks and devices as well as inefficient use of valuable frequency resources. An operator may have one physical network infrastructure and one pool of frequency bands, which may support many separate virtualized networks, also called network slices. Each network slice may have unique characteristics for meeting the specific requirements of the use case/s it serves.

A key function of 5G Core network is to allow for flexibility in network service creation, making use of different network functions suitable for the offered service in a specific network slice, e.g. Evolved Mobile Broadband (MBB), Massive Machine Type Communication (MTC), Critical MTC, Enterprise, etc.

In addition to Service optimized networks there are more drivers for Network slicing, such as;
Business expansion by low initial investment: Given the physical infrastructure it is much easier to instantiate another Packet Core instance for the business expansion than to set up a new parallel infrastructure or even integrated nodes
Low risk by no/limited impact on legacy: As the new instance is logically separated from the other network slices, the network slices can also provide resource isolation between each other. Thus introduction of a new isolated network slice will not impact the existing operator services and therefore only provide low risk
Short Time To Market (TTM): The operators are concerned about the time it takes to set up the network for a new service. Slicing of the network for different services/operator use cases provides a separation of concern that can result in a faster setup of a network slice for a certain service as it is separately managed and with limited impact on other network slices
Optimized use of resources: Today the network is supporting many different services but with new use cases and more diverging requirements there is a need for optimizing the network for the specific type use case. Network slicing allows to match services to optimized network instances, and it also allows for a more optimized use of those specific resources
Allows for individual network statistics: With service specific network slices and possibly even on the level of individual enterprises, there is a possibility of collecting network statistics specific for a limited and well defined group of users of the network slice. This is not the key driver for slicing but rather a benefit that may be a useful tool

Slicing can also be used to isolate different services in an operator's network. Future networks are expected to support new use cases going beyond the basic support for voice services and mobile broadband currently supported by existing cellular network, e.g. 2G/3G/4G. Some example use cases include:
Evolution of MBB
   Evolved communication services
   Cloud services
   Extended mobility and coverage
Mission critical Machine Type Communication
   Intelligent traffic systems
   Smart grid
   Industrial applications
Massive Machine Type Communication
   Sensors/actuators
   Capillary networks
Media
   Efficient on-demand media delivery
   Media awareness
   Efficient support for broadcast services

These use cases are expected to have different performance requirements, e.g. bit-rates, latencies, as well as other network requirements, e.g. mobility, availability, security etc., affecting the network architecture and protocols.

Supporting these use cases could also mean that new players and relations are needed compared to existing cellular networks. For instance it is expected that future networks should address the needs of
Enterprise services
Government services, e.g. national and/or public safety
Verticals industries, e.g. automation, transportation
Residential users

Embodiments herein may be implemented when releasing use of a network slice or similar.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

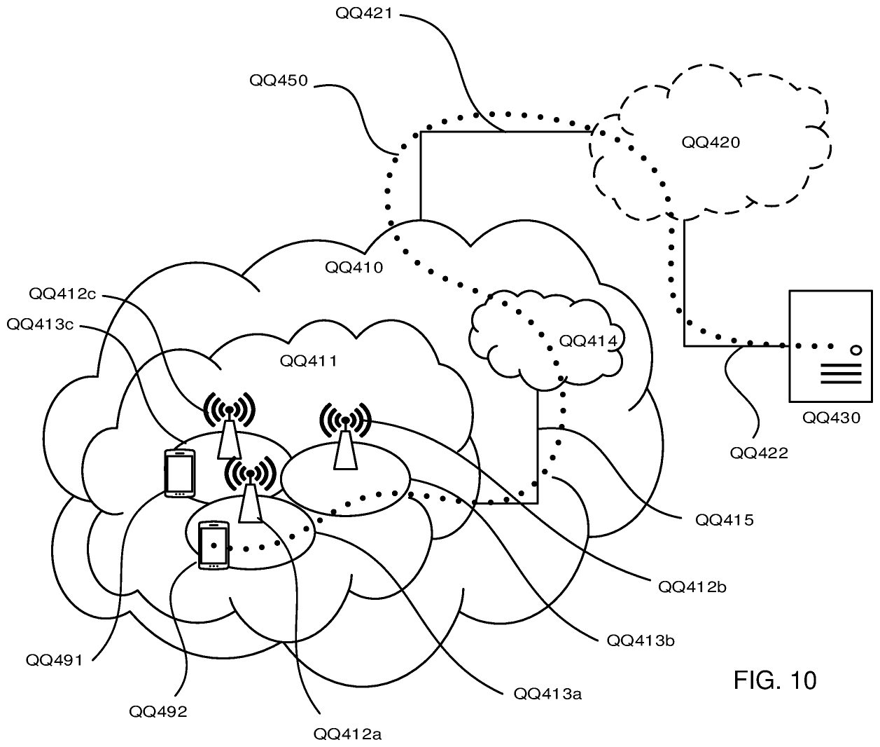

FIG. 10: Telecommunication network connected via an intermediate network to a host computer in accordance with some embodiments

With reference to FIG. 10, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points being examples of the radio network node 12 above, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example being examples of the wireless device 10 above, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. 10 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

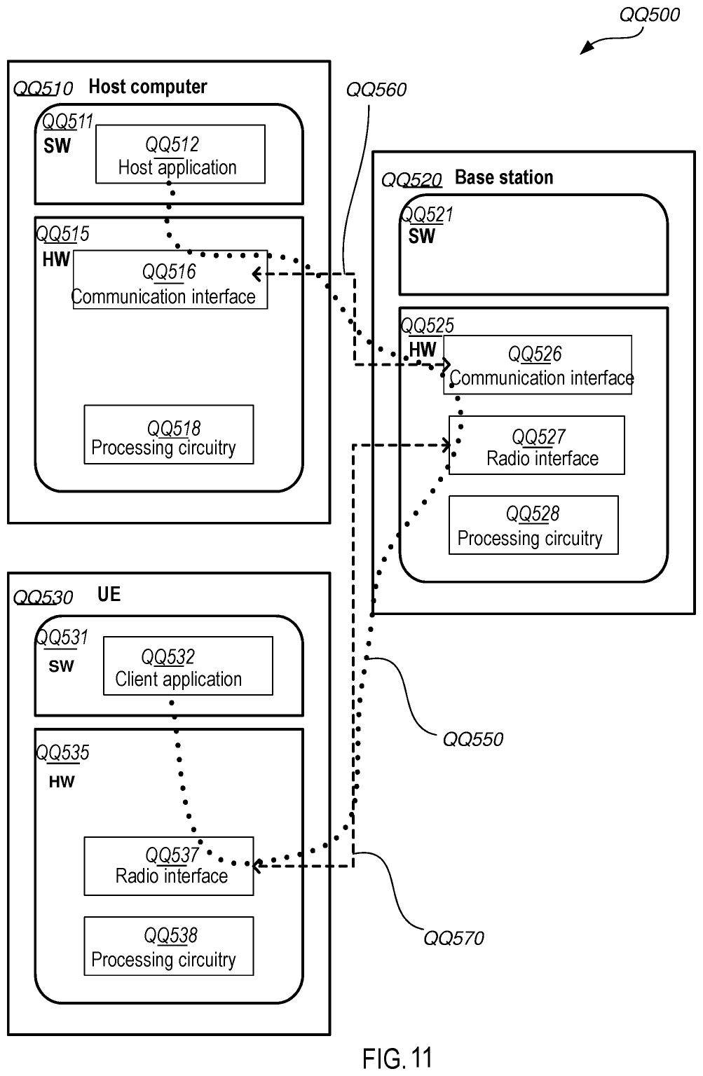

FIG. 11: Host computer communicating via a base station with a user equipment over a partially wireless connection in accordance with some embodiments

Example implementations, in accordance with an embodiment, of the UE, base station and host computer discussed in the preceding paragraphs will now be described with reference to Figure QQ5. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. 11) served by base station QQ520. Communication interface QQ526 may be configured to facilitate connection QQ560 to host computer QQ510. Connection QQ560 may be direct or it may pass through a core network (not shown in FIG. 11) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. It's hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. 11 may be similar or identical to host computer QQ430, one of base stations QQ412a, QQ412b, QQ412c and one of UEs QQ491, QQ492 of FIG. 10, respectively. This is to say, the inner workings of these entities may be as shown in FIG. 11 and independently, the surrounding network topology may be that of FIG. 10.

In FIG. 11, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments improve the performance of OTT services provided to UE QQ530 using OTT connection QQ550, in which wireless connection QQ570 forms the last segment. More precisely, the teachings of these embodiments may improve the latency since the resources may be used in a more efficient manner since there is no ambiguity whether the PDU session is released or not and thereby provide benefits such as reduced waiting time and better responsiveness.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510′s measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

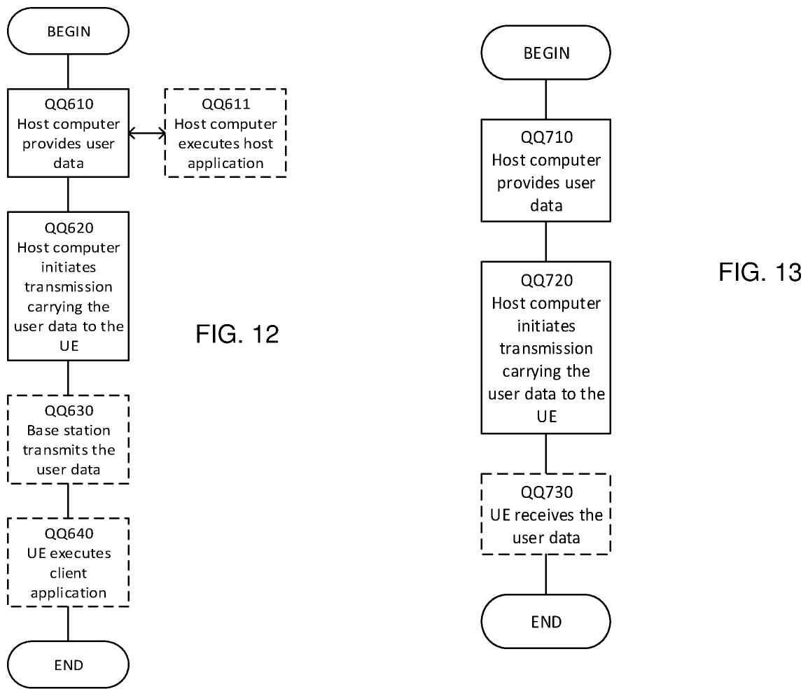

FIG. 12: Methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

FIG. 13: Methods implemented in a communication system including a host computer, a base station and a user equipment in accordance with some embodiments.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

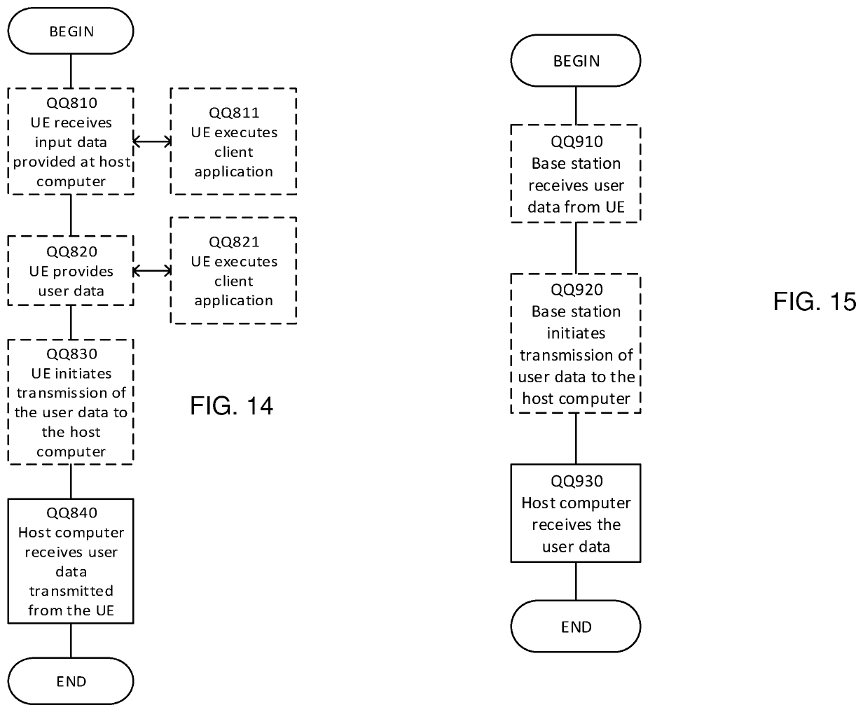

FIG. 14: Methods implemented in a communication system including a host computer, a base station and a user equipment in accordance with some embodiments

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

FIG. 15: Methods implemented in a communication system including a host computer, a base station and a user equipment in accordance with some embodiments

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

Abbreviation Explanation

AS Access Stratum

NG-RAN NG Radio Access Network

PDCP Packet Data Convergence Protocol

NAS Non Access Stratum

NR New Radio, 5G

AMF Access and Mobility Management Function

SMF Session Management Function

5GC 5G Core Network

Appendix A

Discussion

The GBR QoS Flow parameter, “Notification Control” is an optional IE sent from CN to RAN, indicating that “whether notifications are requested from the RAN when the GFBR can no longer be fulfilled for a QoS flow during the lifetime of the QoS flow.”

Corresponding, in TS 38.413, the “PDU Session Resource Notify” has introduced. It is a class 2 procedure and uses the UE associated signalling.

In 5G DC, some QoS flows in the PDU session may be setup in another Node (e.g. SN). When a GBR QoS flow with “Notification Control” set is established in SN, for example, SN node needs to notify the MN node when the QoS requirement can no longer be fulfilled”. Thus a similar class 2 procedure is needed.

The same applies to F1 when there is a CU/DU separation. As it is often the lower layer (DU) who monitors if the QoS requirement is fulfilled or not.

Proposal 1: RAN3 to include a class 2 procedure in Xn, to indicate when the GBR QoS requirement can no longer be fulfilled or be fulfilled again.

Proposal 2: RAN3 to include a class 2 procedure in F1, to indicate from DU to CU when the GBR QoS requirement can no longer be fulfilled or be fulfilled again.

In DC 5G, there are a few different configurations, e.g.
NG-U could either be terminated at MN, PDCP (and SDAP) protocol in SN+RLC/LCH configuration in MN
NG-U could either be terminated at SN, PDCP (and SDAP) protocol in SN+RLC/LCH configuration in MN
NG-U could either be terminated at MN, PDCP (and SDAP) protocol in MN+RLC/LCH configuration in SN
NG-U could either be terminated at MN, PDCP (and SDAP) protocol in MN+RLC/LCH configuration in SN

That is to say that the Notify message is sometimes sent from MN node to SN node, and sometimes sent from SN node to MN node.

Proposal 3: The class 2 Notify procedure in Xn should be defined to be sent from on NG-RAN node to another NG-RAN node, decoupled from the MN node and SN node role.

Currently the “PDU Session Resource Notify” defined in TS 38.413 includes two different cases, one is when NG-RAN node desires to release certain QoS flows, another is when NG-RAN wants to notify the CN that the QoS requirement for certain QoS flow can no longer be fulfilled.

In our opinion, the procedure suits the purpose for notifying the CN, but is not suitable to be used to release the QoS flow. “The list of QoS flows which are released by the NG-RAN node” is included in the message, but are the QoS flows released? What RAN should do for these released QoS flows? TS 38.413 says that upon the reception of the message, “SMF normally initiate the appropriate release procedure”, in order to release those QoS flows.

From the above we can see that three NGAP messages are needed if to use the “PDU Session Resource Notify” to release the QoS flow. It is totally up to SMF to initiate a release procedure or not. But what would happen

if for some reason that SMF does not initiate the release procedure?

If SMF at the same time initiate a modification procedure for the involved QoS flows?

For sure when NG-RAN node wishes to release certain QoS flow, it means that RAN cannot keep the QoS flows any more. RAN needs to handle after having sent release in the “notify” message, but CN initiate “modification” for the QoS flows NG-RAN considered to be released, or there is no “release” coming from CN.

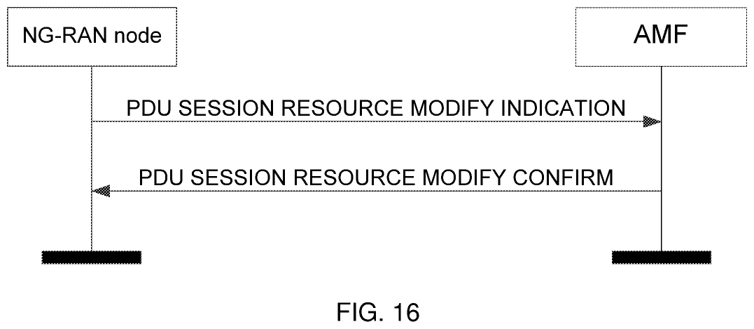

On the other hand, we do have a “PDU Session Resource Modify Indication” procedure initiated by NG-RAN Node, see FIG. 16.

If NG-RAN node uses the above procedure to release the QoS flows, it is only 2 step messages and there is no ambiguity. It is a very robust handling.

It would be much clearer and more robust if we use the PDU Session Resource Notify procedure to notify that the QoS requirement can no longer be fulfilled, or it is being fulfilled again, and it is CN to determine how to handle the related QoS flow. It is a class 2 message.

And we use the PDU Session Resource Modify Indication when NG-RAN decides that certain QoS flow are released. It is a class 1 message.

Proposal 4: RAN3 to agree to use “PDU Session Resource Notify” procedure only be used for Notification purpose, to indicate from NG-RAN node to 5GC when the GBR QoS requirement can no longer be fulfilled or be fulfilled again.

Proposal 5: RAN3 to agree to modify the “PDU Session Resource Modify Indication” procedure to handle the NG-RAN node initiated release of certain QoS flows or PDU sessions.

2 Proposals

Proposal 1: RAN3 to include a class 2 procedure in Xn, to indicate when the GBR QoS requirement can no longer be fulfilled or be fulfilled again.

Proposal 2: RAN3 to include a class 2 procedure in F1, to indicate from DU to CU when the GBR QoS requirement can no longer be fulfilled or be fulfilled again.

Proposal 3: The class 2 Notify procedure in Xn should be defined to be sent from on NG-RAN node to another NG-RAN node, decoupled from the MN node and SN node role.

Proposal 4: RAN3 to agree to use “PDU Session Resource Notify” procedure only be used for notification purpose, to indicate from NG-RAN node to 5GC when the GBR QoS requirement can no longer be fulfilled or be fulfilled again.

Proposal 5: RAN3 to agree to modify the “PDU Session Resource Modify Indication” procedure to handle the NG-RAN node initiated release of certain QoS flows or PDU sessions.

pCRs are submitted in [1], [2].

Text Proposal for NGAP TS 38.423 v0.4.0

<<<<<<<<<<<<<<<<<<<<Begin Text Proposal>>>>>>>>>>>>>>>>>>>>

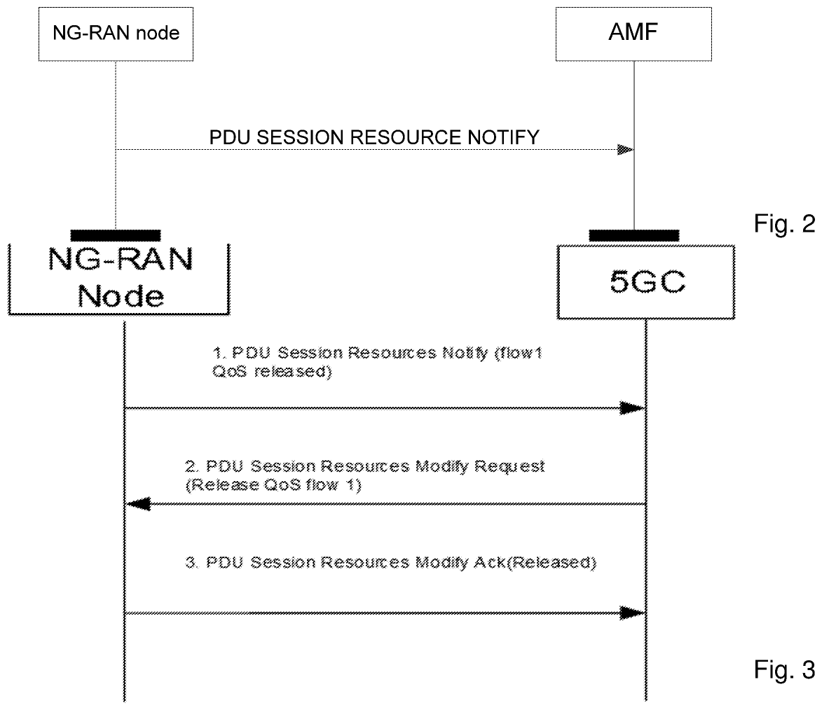

PDU Session Resource Notify (See FIG. 2)

General

The purpose of the PDU Session Resource Notify procedure is to notify that the already established QoS flow(s) or PDU session(s) for a given UE are not fulfilled anymore by the NG-RAN node. The procedure uses UE-associated signalling.

Editor's Note: Further details are FFS, e.g. whether the above text should be more 10 specific on the current purpose which is to “indicate to 5GC that the NG-RAN node resource is not fulfilled” or instead be kept generic as it is.

Successful Operation

The NG-RAN node initiates the procedure by sending a PDU SESSION RESOURCE NOTIFY message.

The PDU SESSION RESOURCE NOTIFY message shall contain the information of PDU sessions or QoS flows which are not fulfilled anymore by the NG-RAN node.
For each PDU session of which some QoS flows are not fulfilled any more by the NG-RAN node, the PDU Session Resource Notify Transfer IE shall be included to report for each PDU session of which some QoS flow(s) are not fulfilled any more [FFS]:
The list of QoS flows which are not fulfilled any more by the NG-RAN node, if any, shall be included in the QoS Flows Not Fulfilled Notify List IE.
For each PDU session which is not fulfilled any more by the NG-RAN node, the PDU Session Resource Notify Transfer IE shall be included to report the non-fulfillment cause in the Cause IE.

Upon reception of the PDU SESSION RESOURCE NOTIFY message, the AMF shall, for each PDU session indicated in the PDU Session ID IE, transfer transparently the PDU Session Resource Notify Transfer IE to each SMF associated with the concerned PDU session. [FFS] Upon reception of PDU Session Resource Notify Transfer IE, SMF normally initiate the appropriate modify procedure on the core network side for the PDU session(s) or QoS flow(s) identified in the PDU SESSION RESOURCE NOTIFY message [FFS].

Editor's Note: Further details are FFS.

Abnormal Conditions

Editor's Note: Further details are FFS.

PDU Session Resource Modify Indication (see FIG. 16)

General

The purpose of the PDU Session Resource Modify Indication procedure is for the NG-RAN node to request modification of the established PDU session(s) or to release the established QoS flows or PDU sessions. The procedure uses UE-associated signalling.

Editor's Note: Further details are FFS.

Successful Operation

The NG-RAN node initiates the procedure by sending a PDU SESSION RESOURCE MODIFY INDICATION message. Upon reception of the PDU SESSION RESOURCE MODIFY INDICATION message, the AMF shall, for each PDU session indicated in the PDU Session ID IE, transparently transfer the PDU Session Resource Modify Indication Transfer IE to each SMF associated with the concerned PDU session. [FFS]
The DL TNL Information IE included in the PDU Session Resource Modify Indication Transfer IE in the PDU SESSION RESOURCE MODIFY INDICATION message shall be considered by the SMF as the new DL address of the PDU sessions. [FFS]
For each QoS flow included in the QoS Flows Release Request List IE included in the PDU Session Resource Modify Indication Transfer IE in the PDU SESSION RESOURCE MODIFY INDICATION message shall be considered by the SMF that the QoS flows are released. [FFS]
For each PDU session included in the PDU session Release Request List IE included in the PDU Session Resource Modify Indication Transfer IE in the PDU SESSION RESOURCE MODIFY INDICATION message shall be considered by the SMF that the PDU sessions are released. [FFS]

The AMF shall report to the NG-RAN node in the PDU SESSION MODIFY RESOURCE CONFIRM message the result for each PDU session listed in PDU SESSION RESOURCE MODIFY INDICATION message:
For each PDU session which is successfully modified, the PDU Session Resource Modify Confirm Transfer IE shall be included to report [FFS]:

1. The list of QoS flows which are modified successfully shall be included in the QoS Flows Modify List IE. [FFS]

2. The list of QoS flows which fail to be modified, if any, shall be included in the QoS Flows Failed To Modify List IE. [FFS]

3. The list of QoS flows which are released successfully, if any, shall be included in the QoS Flows Release List IE. [FFS]

4. The list of QoS flows which failed to be released, if any, shall be included in the QoS Flows Failed To Release List IE. [FFS]
For each PDU session which failed to be modified or released, the PDU Session Resource Modify Confirm Transfer IE shall be included to report the failure cause.
For each PDU session or the PDU sessions with some QoS Flows are released successfully, the NAS-PDU shall be included in PDU Session Resource Modify Confirm message.

Upon reception of the PDU Session Resource Modify Confirm Transfer IE for each PDU session listed in the PDU SESSION RESOURCE MODIFY CONFIRM message:
If the QoS Flows Failed To Modify List IE is included, the NG-RAN node shall either

1. de-associate the corresponding Data Radio Bearer for the concerned QoS flow, or

2. keep the previous transport information before sending the PDU SESSION RESOURCE MODIFY INDICATION unchanged for the concerned QoS flow.
If a PDU session failed to be modified is included, the NG-RAN node shall either

1. release all corresponding NG-RAN configuration and resources for the concerned PDU session, or

2. keep the previous transport information before sending the PDU SESSION RESOURCE MODIFY INDICATION unchanged for the concerned PDU session. The NG-RAN node shall pass the NAS-PDU IE received for the PDU session to the UE and de-associate the corresponding Data Radio Bearer for the released QoS flow or PDU sessions.
If the QoS Flows Failed To Release List IE is included, the NG-RAN node shall either

1. de-associate the corresponding Data Radio Bearer for the concerned QoS flow, or

2. resending the PDU SESSION RESOURCE MODIFY INDICATION unchanged for the concerned QoS flow.

Editor's Note: Further details are FFS.

Unsuccessful Operation

Editor's Note: Further details are FFS.

Abnormal Conditions

Editor's Note: Further details are FFS.

Skip to next change

PDU Session Resource Notify

Editor's Note: Message structure and IEs need further checking and completion. Further details FFS.

This message is sent by the NG-RAN node to notify that the already established QoS flow(s) or PDU session(s) for a given UE are not fulfilled any more by the NG-RAN node.

Editor's Note: Further details are FFS, e.g. whether the above text should be more specific on the current purpose which is to “indicate to 5GC that the NG-RAN node resource is not fulfilled” or instead be kept generic as it is.

Direction: NG-RAN node→AMF

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | 9.3.1.1 | YES | ignore |
| AMF UE NGAP ID | M | | 9.3.3.1 | YES | reject |
| RAN UE NGAP ID | M | | 9.3.3.2 | YES | reject |
| PDU Session | | 0 . . . 1 | | YES | reject |
| Resource Notify List | | | | | |
| >PDU Session | | 1 . . . | | EACH | reject |
| Resource Notify Item | | <maxnoofPDUSessions> | | | |
| IEs | | | | | |
| >>PDU Session ID | M | | <ref> | — | |
| >>PDU Session | M | | 9.3.1.18 | — | |
| Resource Notify | | | | | |
| Transfer | | | | | |

| Range bound | Explanation |
|---|---|
| maxnoofPDUSessions | Maximum no. of PDU sessions allowed |
| | towards one UE. Value is FFS. |

PDU Session Resource Modify Indication

Editor's Note: Message structure and IEs need further checking and completion. Further details FFS.

This message is sent by the NG-RAN node and is used to request the AMF to enable modifications or release of already established PDU sessions for a given UE.

Direction: NG-RAN node→AMF

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | 9.3.1.1 | YES | reject |
| AMF UE NGAP ID | M | | 9.3.3.1 | YES | reject |
| RAN UE NGAP ID | M | | 9.3.3.2 | YES | reject |
| PDU Session | | 1 | | YES | reject |
| Resource Modify | | | | | |
| Indication List | | | | | |
| >PDU Session | | 1 . . . | | EACH | reject |
| Resource Modify | | <maxnoofPDUSessions> | | | |
| Indication Item IEs | | | | | |
| >>PDU Session ID | M | | <ref> | — | |
| >>PDU Session | M | | 9.3.1.19 | — | |
| Resource Modify | | | | | |
| Indication Transfer | | | | | |

| Range bound | Explanation |
|---|---|
| maxnoofPDUSessions | Maximum no. of PDU sessions allowed |
| | towards one UE. Value is FFS. |

PDU Session Resource Modify Confirm

Editor's Note: Message structure and IEs need further checking and completion. Further details FFS.

Editor's Note: It is FFS whether Cause IE for PDU session failed to be modified by the 5GC is captured in the PDU Session Modify Confirm Transfer.

This message is sent by the AMF and is used to confirm the outcome of the request from the PDU SESSION RESOURCE MODIFY INDICATION message.

Direction: AMF→NG-RAN node

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | 9.3.1.1 | YES | reject |
| AMF UE NGAP ID | M | | 9.3.3.1 | YES | reject |
| RAN UE NGAP ID | M | | 9.3.3.2 | YES | reject |
| PDU Session | | 0 . . . 1 | | YES | reject |
| Resource Modify | | | | | |
| Confirm List | | | | | |
| >PDU Session | | 1 . . . | | EACH | reject |
| Resource Modify | | <maxnoofPDUSessions> | | | |
| Confirm Item IEs | | | | | |
| >>PDU Session ID | M | | <ref> | — | |
| >>PDU Session | M | | 9.3.1.20 | — | |
| Resource Modify | | | | | |
| Confirm Transfer | | | | | |
| >>NAS-PDU | O | | 9.3.3.4 | | |
| >>S-NSSAI [FFS] | O | | <ref> | — | |
| Criticality Diagnostics | O | | 9.3.1.3 | YES | ignore |

| Range bound | Explanation |
|---|---|
| maxnoofPDUSessions | Maximum no. of PDU sessions allowed |
| | towards one UE. Value is FFS. |

Skip to next change

PDU Session Resource Notify Transfer

Editor's Note: Further details FFS.

This IE is sent transparently by the AMF.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| CHOICE PDU Session | M | | | YES | reject |
| Resource Notify | | | | | |
| Transfer | | | | | |
| >QoS Flows Notify | | | | — | |
| >>QoS Flows Notify | | 1 . . . | | — | |
| List | | <maxnoofQoSFlows> | | | |
| >>>QoS Flow | M | | <ref> | EACH | reject |
| Indicator | | | | | |
| >>>Fulfillness | M | | ENUMERATED | — | — |
| | | | (Fullfilled, Not | | |
| | | | Fulfilled) | | |
| >>>Assistance | O | | <ref> | — | |
| Information [FFS] | | | | | |
| >PDU Session | | | | — | |
| Resource Notify | | | | | |
| >>Fulfillness | M | | ENUMERATED | YES | reject |
| | | | (Fullfilled, Not | | |
| | | | Fulfilled) | | |
| >>Cause [FFS] | O | | 9.3.1.2 | — | |

| Range bound | Explanation |
|---|---|
| maxnoofQoSFlows | Maximum no. of QoS flows allowed |
| | within one PDU session. Value is FFS. |

PDU Session Resource Modify Indication Transfer

Editor's Note: Further details FFS.

This IE is sent transparently by the AMF.

| | | | IE type and | Semantics |
|---|---|---|---|---|
| IE/Group Name | Presence | Range | reference | description |
| CHOICE PDU Session | M | | | |
| Resource Modify | | | | |
| Indication Transfer | | | | |
| >PDU Session Modify | | | | |
| >>DL TNL Information | M | | TNL Information | One or multiple |
| | | | 9.3.2.1 | RAN Transport |
| | | | | Layer Information |
| >QoS Flows Released | | | | |
| >>QoS Flows | M | | QoS Flow List | |
| Release List | | | <ref> | |
| >>Cause | O | | ref | |
| >PDU Session | | | | |
| Released | | | | |
| >>Cause | O | | ref | |

PDU Session Resource Modify Confirm Transfer

Editor's Note: Further details FFS.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| CHOICE PDU Session | M | | | YES | reject |
| Resource Modify | | | | | |
| Confirm Transfer | | | | | |
| >PDU Session | | | | — | |
| Resource Modify | | | | | |
| Success Confirm | | | | | |
| >>QoS Flows Modify | | 1 | | — | |
| List | | | | | |
| >>>QoS Flows | | 1 . . . | | — | |
| Modify Item IEs | | <maxnoofQoSFlows> | | | |
| >>>>QoS Flow | M | | <ref> | EACH | reject |
| Indicator | | | | | |
| >>QoS Flows Failed | O | | QoS Flow List | YES | ignore |
| To Modify List | | | <ref> | | |
| >PDU Session | | | | — | |
| Resource Modify | | | | | |
| Failure Confirm [FFS] | | | | | |
| >>Cause [FFS] | M | | 9.3.1.2 | — | |
| >PDU Session | | | | — | |
| Resource Released | | | | | |
| Success Confirm | | | | | |
| >>QoS Flows | O | | QoS Flow List | YES | reject |
| Release List | | | <ref> | | |
| >>QoS Flows Failed | O | | QoS Flow List | YES | ignore |
| To Release List | | | <ref> | | |
| >PDU Session | | | | — | |
| Resource Release | | | | | |
| Failure Confirm [FFS] | | | | | |
| >>Cause [FFS] | M | | 9.3.1.2 | — | |

| Range bound | Explanation |
|---|---|
| maxnoofQoSFlows | Maximum no. of QoS flows allowed |
| | within one PDU session. Value is FFS. |

<<<<<<<<<<<<<<<<<<<<End Text Proposal>>>>>>>>>>>>>>>>>>>>

1-18. (canceled)

19. A method performed by a radio network node for handling an update of a protocol data unit, PDU, session, for a wireless device in a wireless communication network, the method comprising:
transmitting to a network node, an indication indicating one or more quality of service, QoS, flows or PDU sessions to be released;
receiving a confirmation indication from the network node, wherein the confirmation indication indicates one or more QoS flows or PDU sessions released and/or not released; and
handling the update of the PDU session based on the received confirmation indication.

20. The method according to claim 19, wherein handling comprises handling release of one or more QoS flows of the PDU session.

21. The method according to claim 19, further comprising:
determining to update the PDU session of the wireless device.

22. The method according to claim 19, wherein transmitting the indication indicating one or more QoS flows or PDU sessions to be released further comprises transmitting a cause of the release.

23. The method according to claim 19, wherein handling the update comprises: passing a non-access stratum, NAS, PDU received for the PDU session to the wireless device; initiating a reconfiguration towards the wireless device; and/or de-associating a corresponding Data Radio Bearer for the released one or more QoS flows or PDU sessions.

24. A method performed by a network node for handling an update of a protocol data unit, PDU, session for a wireless device in a wireless communication network, the method comprising:
receiving an indication from a radio network node, wherein the indication indicates one or more quality of service, QoS, flows or PDU sessions to be released; and
transmitting a confirmation indication to the radio network node, which confirmation indication indicates one or more QoS flows or PDU sessions released or not released.

25. The method according to claim 24, further comprising receiving from the radio network node an indication indicating cause of the release.

26. The method according to claim 24, wherein the confirmation indication indicates one or more QoS flows or PDU sessions failed to be released and a failure cause.

27. A radio network node for handling an update of a protocol data unit, PDU, session, for a wireless device in a wireless communication network, wherein the radio network node is configured to:
transmit to a network node, an indication indicating one or more quality of service, QoS, flows or PDU sessions to be released;
receive a confirmation indication from the network node, wherein the confirmation indication indicates one or more QoS flows or PDU sessions released and/or not released; and
handle the update of the PDU session based on the received confirmation indication.

28. The radio network node according to claim 27, wherein the radio network node is configured to handle the update by being configured to handle release of one or more QoS flows of the PDU session.

29. The radio network node according to claim 27, wherein the radio network node is further configured to determine to update the PDU session of the wireless device.

30. The radio network node according to claim 27, wherein the radio network node is further configured to transmit a cause of the release.

31. The radio network node according to claim 27, wherein the radio network node is configured to handle the update by being configured to pass a non-access stratum, NAS, PDU received for the PDU session to the wireless device; initiate a reconfiguration towards the wireless device; and/or de-associate a corresponding Data Radio Bearer for the released one or more QoS flows or PDU sessions.

32. A network node for handling an update of a protocol data unit, PDU, session for a wireless device in a wireless communication network, wherein the network node is configured to:
receive an indication from a radio network node, wherein the indication indicates one or more quality of service, QoS, flows or PDU sessions to be released; and
transmit a confirmation indication to the radio network node, which confirmation indication indicates one or more QoS flows or PDU sessions released or not released.

33. The network node according to claim 32, wherein the network node is configured to receive from the radio network node, an indication indicating cause of the release.

34. The network node according to claim 32, wherein the confirmation indication indicates one or more QoS flows or PDU sessions failed to be released and a failure cause.
